(19) United States
(12) Patent Application Publication
(10) Pub. No.: US 2026/0264435 A1
(43) Pub. Date: Sep. 10, 2026

(54) PRINTING APPARATUS AND CONTROL METHOD

(71) Applicant: CANON KABUSHIKI KAISHA, Tokyo (JP)

(72) Inventors: JUN YASUTANI, Kanagawa (JP); YOSHIAKI MURAYAMA, Tokyo (JP); TAKUTO MORIGUCHI, Kanagawa (JP); SATOSHI AZUMA, Tokyo (JP); KENTARO MURO, Tokyo (JP); OSAMU YOSHITAKE, Chiba (JP); TORU OHNISHI, Kanagawa (JP); TATSUAKI ORIHARA, Tokyo (JP); YUTARO NAKATSUKA, Kanagawa (JP); TATSUYA TANAKA, Tokyo (JP)

(21) Appl. No.: 19/555,441

(22) Filed: Mar. 3, 2026

(30) Foreign Application Priority Data
Mar. 4, 2025 (JP) 2025-034030

(51) Int. Cl. B41J 29/393; B41J 2/045; B41J 2/155; B41J 3/44

(52) U.S. Cl. CPC B41J 29/393; B41J 2/04573; B41J 2/04586; B41J 2/155; B41J 3/44; B41J 2029/3935

(57) ABSTRACT

A printing apparatus includes a conveyance unit configured to convey a print medium in a first direction, a printing unit including at least one printhead configured to discharge a liquid to the print medium, a reading unit including a plurality of reading elements arrayed in a second direction crossing the first direction, a specifying unit configured to specify a reading error arising from a curve of the reading unit in the first direction, and a correcting unit configured to set a correction value for correcting a shift of a print position of the printing unit based on a reading result by the reading unit from a test pattern printed on the print medium by the printing unit, and the reading error specified by the specifying unit.

### BACKGROUND

### Field of the Technology

The present disclosure relates to a printing apparatus and a control method.

### Description of the Related Art

There is known a long printhead having a long print width with a plurality of printing chips joined in the nozzle array direction. A printhead called a full-line head is an example of such a printhead. The installation error of such a printhead influences a print position shift (for example, ink landing position shift). This shift degrades the print quality. To solve this, there is provided a technique of reading, by a reading unit such as a scanner, a test pattern printed by a printhead, and correcting the print position shift of the printhead from the reading result (for example, Japanese Patent Laid-Open No. 2012-166385).

A reading unit sometimes deforms owing to the influence of heat at the time of manufacturing or the like. The reading result of the reading unit includes a reading error arising from the deformation, so the correction accuracy of a print position shift may decrease.

### SUMMARY

The present disclosure provides a technique of improving the correction accuracy of a print position shift.

According to an aspect of the present disclosure, there is provided a printing apparatus comprising: a conveyance unit configured to convey a print medium in a first direction; a printing unit including at least one printhead configured to discharge a liquid to the print medium; a reading unit including a plurality of reading elements arrayed in a second direction crossing the first direction; a specifying unit configured to specify a reading error arising from a curve of the reading unit in the first direction; and a correcting unit configured to set a correction value for correcting a shift of a print position of the printing unit based on a reading result by the reading unit from a test pattern printed on the print medium by the printing unit, and the reading error specified by the specifying unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of a printing apparatus according to an embodiment of the present disclosure.

FIG. 2 is a block diagram showing the circuit configuration of a printing control system in the printing apparatus of FIG. 1.

FIG. 3 is a block diagram showing the internal configuration of a scanner unit.

FIG. 4 is an explanatory view of the configuration of a reading unit.

FIG. 5 is an explanatory view of another configuration example of the reading unit.

FIG. 6 is an explanatory view of the configuration of a printhead.

FIG. 7 is an explanatory view of time-division driving.

FIG. 8A is a schematic view showing an example of a test pattern.

FIG. 8B is a schematic view showing the example of the test pattern.

FIG. 9 is a view of details of a pattern matching pattern.

FIG. 10 is a view showing the correspondence between a pattern and discharge nozzles.

FIG. 11 is a view showing a method of calculating a shift amount between printing chips in the X direction.

FIG. 12 is a schematic view showing an example of a method of correcting an inclination between printheads.

FIG. 13 is a view showing an example of the influence of the curve of the reading unit.

FIG. 14 is a flowchart showing an example of a method of setting a correction value.

FIG. 15 is a view schematically showing the method in FIG. 14.

FIG. 16 is a view showing a method of calculating a shift amount between the printing chips in the X direction.

FIG. 17 is a flowchart showing an example of another method of setting a correction value.

FIG. 18 is a graph showing an example of a graph obtained by plotting the shifts of the barycenters of tile patterns read by a line sensor having a curve component.

FIG. 19 is a schematic view showing measurement information.

FIG. 20 is a view showing an example of a reading unit and a master chart.

FIG. 21 is a flowchart showing a sequence of correction of a curve component using the master chart.

FIG. 22 is a view showing the corrected image of a read image.

FIG. 23 is a graph showing each shift amount when a test pattern is read twice.

FIG. 24 is a graph showing the curve component of the line sensor.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### (Outline of Printing Apparatus)

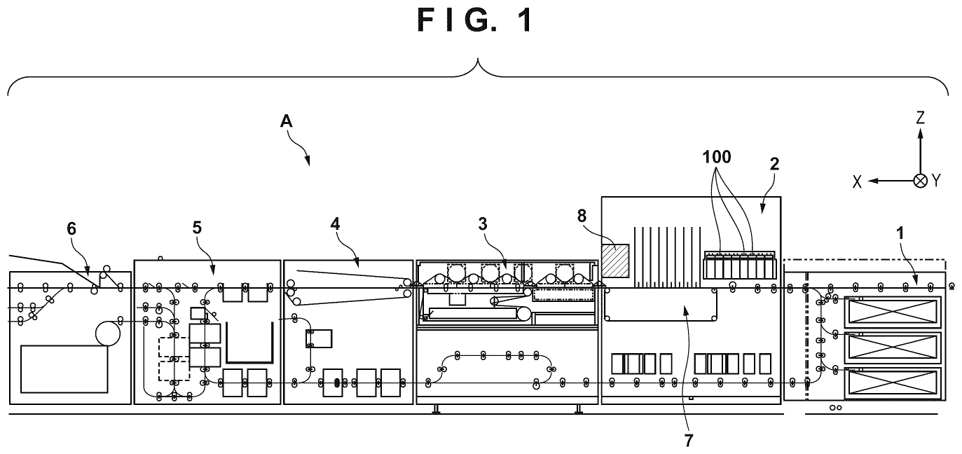

FIG. 1 is a schematic view of a printing apparatus A according to an embodiment of the present disclosure. The printing apparatus A is an apparatus that discharges a liquid to a print medium to print an image.

Note that “printing” not only includes the formation of significant information such as characters and graphics but also broadly includes the formation of images, figures, patterns, and the like on a print medium, or the processing of the medium, regardless of whether they are significant or insignificant and whether they are so visualized as to be visually perceivable by humans. In addition, this embodiment assumes a sheet of paper as “print medium” but may use cloth, a plastic film, and the like.

In each drawing, arrows X and Y indicate horizontal directions crossing each other, and are orthogonal to each other in this embodiment. An arrow Z indicates a vertical direction.

As shown in FIG. 1, the printing apparatus A according to this embodiment includes a paper feed unit 1 that feeds a sheet such as a cut sheet as a print medium, and a printing unit 2 that prints by discharging a liquid to a sheet. The printing apparatus A also includes a fixing unit 3 that performs non-contact heating on an image-printed sheet, a fixing unit 4 that performs contact heating, a cooling/reversing unit 5 that performs cooling of a sheet and a reversing operation in double-sided printing, and a discharge unit 6 on which products are stacked.

The printing unit 2 discharges a liquid to a sheet conveyed by a conveyance unit 7. The conveyance unit 7 is a belt conveyance mechanism that conveys a sheet while fixing the sheet on a belt by air suction. The printing unit 2 includes a plurality of printheads 100 arrayed in the X direction so as to face the belt of the conveyance unit 7. In the printing unit 2, a sheet is conveyed in the X direction by the conveyance unit 7, and during the conveyance, a liquid is discharged to the sheet from the liquid discharge surfaces (lower surfaces) of the printheads 100. As a result, an image is printed on the sheet. The X direction in the printing unit 2 is the sheet conveyance direction and thus is sometimes called a sub-scanning direction.

The printheads 100 discharge, for example, liquids of different types. The types of discharged liquids are, for example, a pretreatment solution (P), and black (K), cyan (C), magenta (M), and yellow (Y) inks. That is, in this embodiment, five printheads 100 are provided. The printhead 100 according to this embodiment is a full-line head whose longitudinal direction is the Y direction in which a plurality of nozzles are arrayed. The Y direction can be called a main scanning direction.

A scanner unit 8 is provided at the final stage of the belt of the conveyance unit 7 on the downstream side of the printing unit 2 in the sheet conveyance direction (X direction). The scanner unit 8 is an inline scanner unit that reads an image printed on a sheet.

### (Printing Control System)

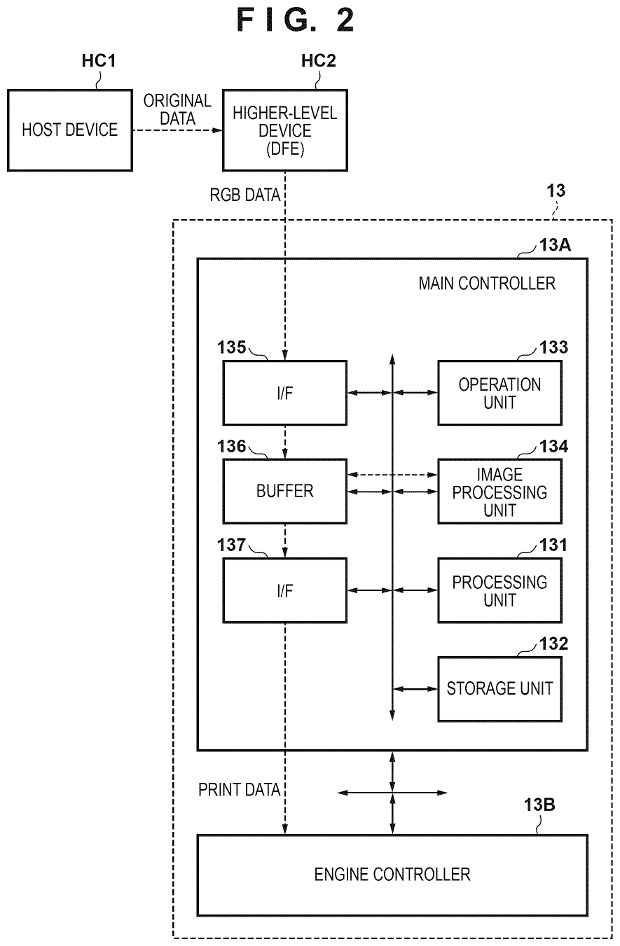

FIG. 2 is a block diagram showing the electronic circuit configuration of a printing control system in the printing apparatus A. A printing control system 13 of the printing apparatus A is communicably connected to a higher-level device (DFE) HC2, and a higher-level device HC2 is communicably connected to a host device HC1.

The host device HC1 is, for example, a personal computer of a user that generates and saves original data serving as the original of a print image. The original data is generated in the format of, for example, an electronic file such as a document file or an image file. The original data is transmitted to the higher-level device HC2. The higher-level device HC2 converts the received original data into a data format usable in the printing control system 13, for example, RGB data expressing an image by RGB. The converted data is transmitted from the higher-level device HC2 to the printing control system 13 of the printing apparatus A.

The printing control system 13 is roughly divided into a main controller 13A and an engine controller 13B. The main controller 13A includes a processing unit 131, a storage unit 132, an operation unit 133, an image processing unit 134, a communication interface (I/F) 135, a buffer 136, and a communication I/F 137. The processing unit 131 is a processor such as a CPU. The processing unit 131 executes a program stored in the storage unit 132, and performs overall control of the main controller 13A. The storage unit 132 is a storage device such as a RAM, a ROM, a hard disk, or an SSD. The storage unit 132 stores programs to be executed by the processing unit 131, and data, and provides a work area to the processing unit 131. The operation unit 133 is, for example, an input device such as a touch panel, a keyboard, or a mouse, and accepts a user instruction.

The image processing unit 134 is, for example, an electronic circuit having an image processor. The buffer 136 is, for example, a RAM, a hard disk, or an SSD. The communication I/F 135 communicates with the higher-level device HC2, and the communication I/F 137 communicates with the engine controller 13B.

In FIG. 2, arrows of broken lines exemplify the flow of processing of data input to the printing control system 13. Data received from the higher-level device HC2 via the communication I/F 135 is accumulated in the buffer 136. The image processing unit 134 reads out the data from the buffer 136, and performs predetermined image processing on the readout data to generate print data to be used by a print engine, and store it again in the buffer 136.

The print data after the image processing that is stored in the buffer 136 is transmitted from the communication I/F 137 to the engine controller 13B. Printing elements provided in each printhead 100 are driven based on the print data, performing a printing operation.

Note that a form including one processing unit 131, one storage unit 132, and one image processing unit 134 has been described here, but a form including a plurality of processing units 131, a plurality of storage units 132, and a plurality of image processing units 134 may be adopted.

### (Scanner Unit)

The scanner unit 8 includes, for example, a sensor with aligned reading elements (not shown), such as a CCD sensor or a CMOS sensor, and can read an original having a width of the printhead 100 in the longitudinal direction or a width of a maximum-width print medium with which the printing apparatus A can deal.

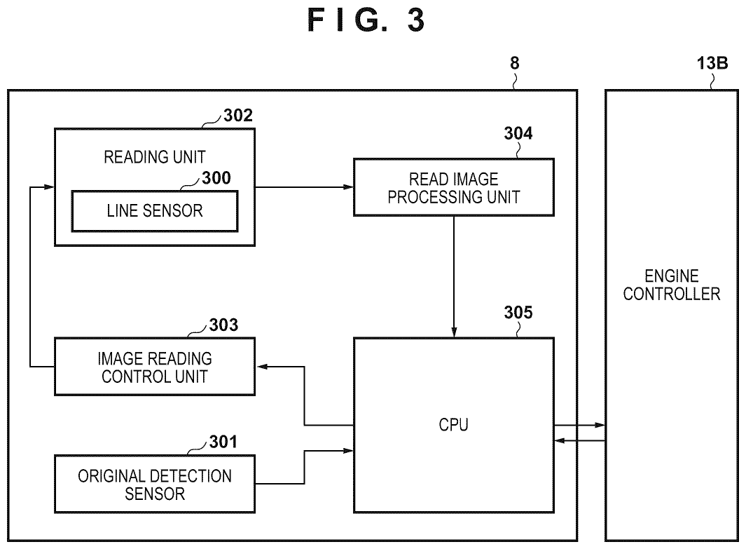

FIG. 3 is a block diagram showing the internal configuration of the scanner unit 8. The scanner unit 8 includes a reading unit 302, an original detection sensor 301, an image reading control unit 303, a read image processing unit 304, and a CPU 305. The CPU 305 controls the operations of the reading unit 302 and read image processing unit 304. The CPU 305 can communicate with the engine controller 13B in FIG. 2.

The reading unit 302 is a contact image sensor (CIS) unit including a line sensor 300, and reads an image printed on a sheet line by line. The image reading control unit 303 drives the reading unit 302. When the CPU 305 obtains from the original detection sensor 301 a detection signal representing that a print medium has been detected, the image reading control unit 303 drives the reading unit 302. The reading unit 302 reads an image from the print medium under the control of the image reading control unit 303 and transmits, to the read image processing unit 304, image data representing the read image.

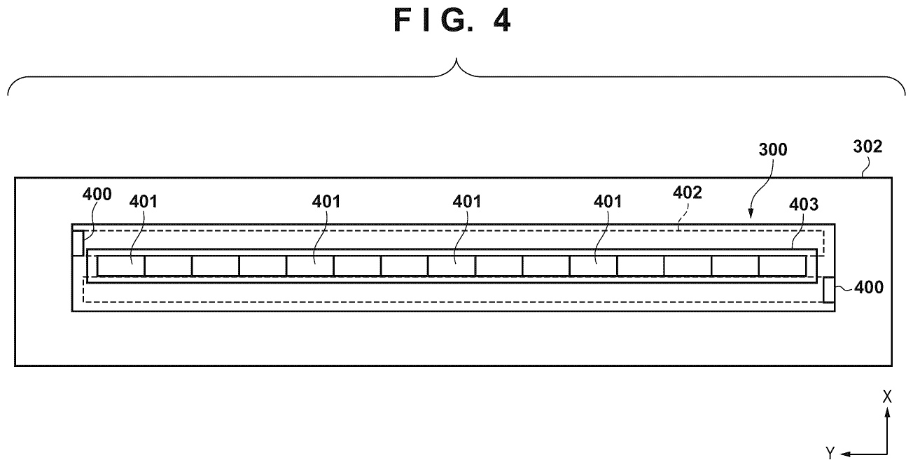

FIG. 4 is an explanatory view of the configuration of the reading unit 302. The line sensor 300 of the reading unit 302 includes a light emitter 400, a light guide 402, a lens array 403, and a sensor chip group formed from a plurality of sensor chips 401.

The lens array 403 guides, to the sensor chips 401, light that is emitted from the light emitter 400 and reflected by a print medium. The sensor chip group is constituted by aligning a plurality of photoelectric conversion elements (sensor chips 401) linearly in the main scanning direction.

One sensor chip 401 reads an image of one pixel. The sensor chips 401 have a three-line configuration in which one line is coated with a red (R) color filter, another line is coated with a green (G) color filter, and still another line is coated with a blue (B) color filter. The light guided by the lens array 403 forms an image on the light receiving surface of each sensor chip 401 of the sensor chip group.

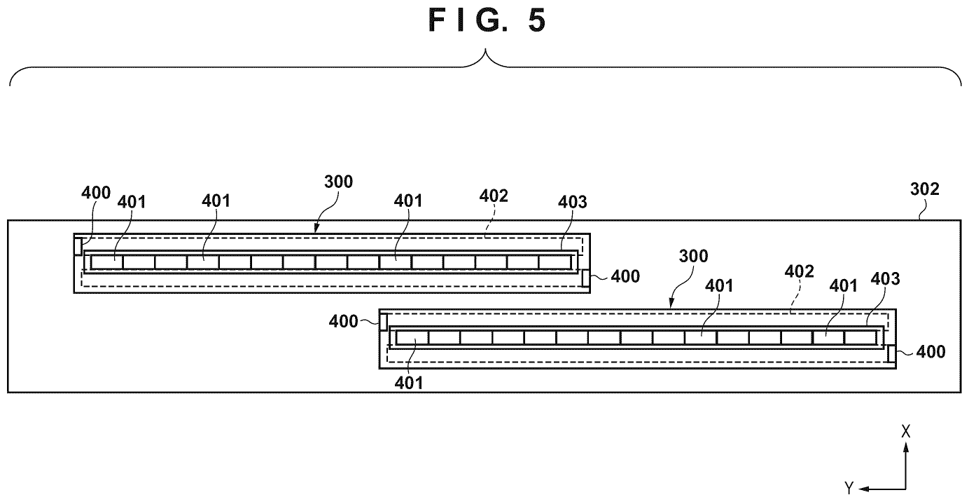

Note that the reading unit 302 has one long line sensor 300 in this embodiment, but a plurality of line sensors 300 may be arrayed in the main scanning direction. For example, two line sensors 300 may be staggered and arranged while partially overlapping each other in the Y direction, as shown in FIG. 5.

Next, the position shift of the line sensor 300 will be explained. A factor of the position shift of the line sensor 300 is, for example, the deformation of the reading unit 302 at the time of manufacturing and distribution and by thermal influence during its service life. The line sensor 300 is manufactured by combining members different in physical properties, so a deformation such as expansion or contraction by heat can occur. As a measure against the deformation, two ends of the line sensor 300 may be firmly positioned using support members or the like. However, an arched deformation (to be referred to as a curve hereinafter) can occur in the X direction near the center of the line sensor 300. The curve of the line sensor 300 has an influence on correcting the print position of the printhead 100 by about several tens of microns. This embodiment provides a technique of canceling a reading error arising from the curve of the line sensor 300, which will be described later.

### (Configuration of Printhead)

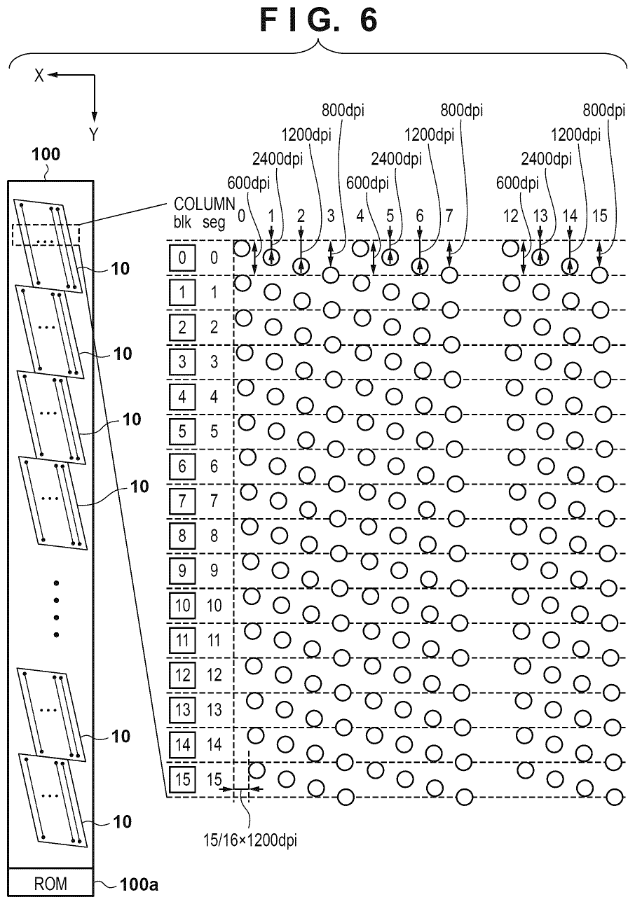

FIG. 6 is a view showing one of the printheads 100 when viewed from the ink discharge surface side. As shown in FIG. 6, the printhead 100 is constituted by connecting in the Y direction a plurality of printing chips 10 each shaped into a parallelogram. This embodiment assumes a configuration in which each printhead 100 is constituted by 17 printing chips 10.

On each printing chip 10, 16 nozzle arrays are arranged. Note that the number of nozzle arrays is not limited to this, and another number is also possible. When a printing resolution of 2,400 dpi is achieved by four nozzle arrays, the number of nozzle arrays is preferably an integral multiple of four.

Although each nozzle array is arranged in the longitudinal direction of the printhead 100, that is, the Y direction as a whole, nozzles constituting each nozzle array are obliquely arranged in the X direction at a pitch corresponding to a 600-dpi resolution. In this embodiment, the nozzles of each nozzle array are arrayed at the pitch corresponding to the 600-dpi resolution, and nozzles are shifted and arranged in the nozzle array direction at every ¼ pitch between arrays. Four successive nozzle arrays, for example, arrays 0 to 3 and arrays 4 to 7 can be combined and used to achieve printing at the resolution of 2,400 dpi in the Y direction.

In FIG. 6, a number indicated at blk represents a block number assigned to each nozzle. In this embodiment, a resolution at which one pixel is driven in the X direction is 1,200 dpi, nozzles assigned with block numbers are selected by time division, and selected printing elements (heaters) are driven, thereby printing an image. In the time-division driving, 16 nozzles (seg0 to seg15) successive in the Y direction are grouped into one, the nozzles of each nozzle array are divided into a plurality of groups, and the nozzles of each group are driven in order. As for printing of the same single pixel in the X direction, seg15 is driven with a delay of (15/16)×1200 dpi with respect to seg0.

A ROM 100a that stores information unique to the printhead 100 can be provided in the printhead 100. The ROM 100a may be an EEPROM.

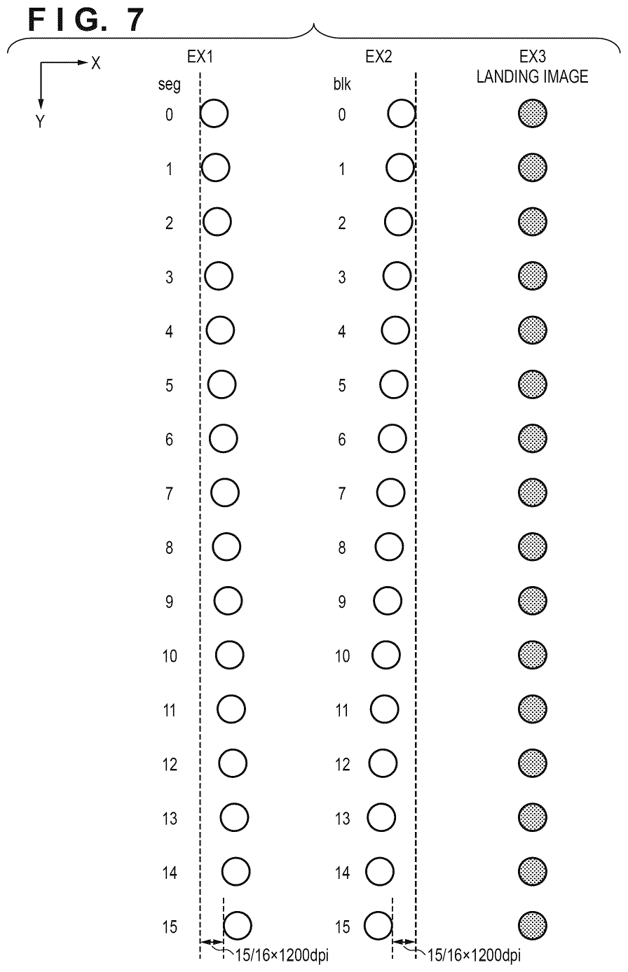

FIG. 7 is a view showing a nozzle arrangement, time-division driving, and a landing state. Here, 16 successive nozzles constituting one group in time-division driving will be explained. As represented by EX1 in FIG. 7, 16 nozzles are shifted and arranged in the X direction. With this shift, the timing of time-division driving is set as represented by EX2 so as to cancel the shift amounts and directions of landed ink droplets. By executing such time-division driving, ink landing straightens in the Y direction, as represented by EX3.

Note that FIG. 7 shows an example in which 16 nozzles are shifted and arranged by an amount equivalent to (15/16)×1200 dpi in the X direction with respect to the landing shift amount by time-division driving of 16 nozzles. However, only some of 16 nozzles may be shifted and arranged in the X direction.

### (Landing Position Shift)

Next, types of shifts (also called head position shifts) of constituent elements of the printhead 100 will be explained. All head position shifts arise from the manufacturing tolerances of the printing chip 10 and nozzles of the printhead 100, the tolerance of the arrangement of the printing chip 10, and the like. Types of head position shifts are an inter-array shift (X direction) between nozzle arrays in the printing chip 10, an inter-chip shift (X and Y directions) of the printing chip 10, and an inter-head shift (inter-color shift, (X and Y directions)) between the printheads 100.

If such a head position shift exists, the landing position of an ink droplet shifts from an ideal position in the X and Y directions, degrading the quality of a print image. Correction of the landing position of a liquid arising from the head position shift can be performed by changing the ink discharge timing of the printhead 100 or selection of discharge nozzles in the Y direction. As a premise for this, a test pattern is printed on a sheet by the printing unit 2, and read by the reading unit 302 to analyze the landing position shift.

### (Test Pattern)

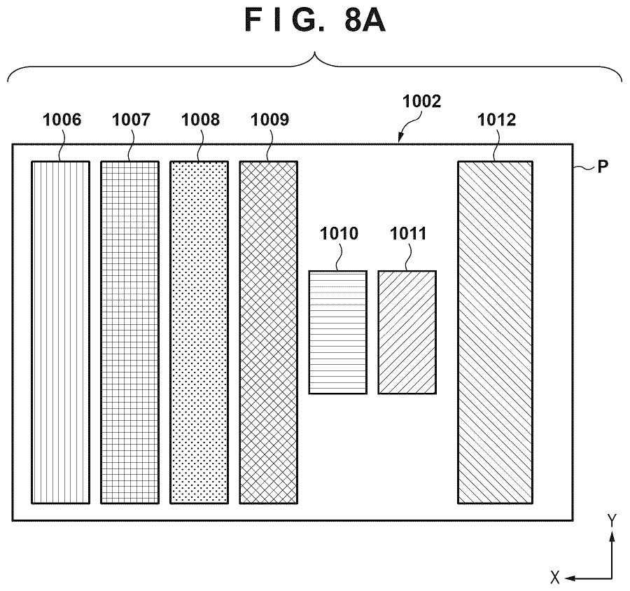

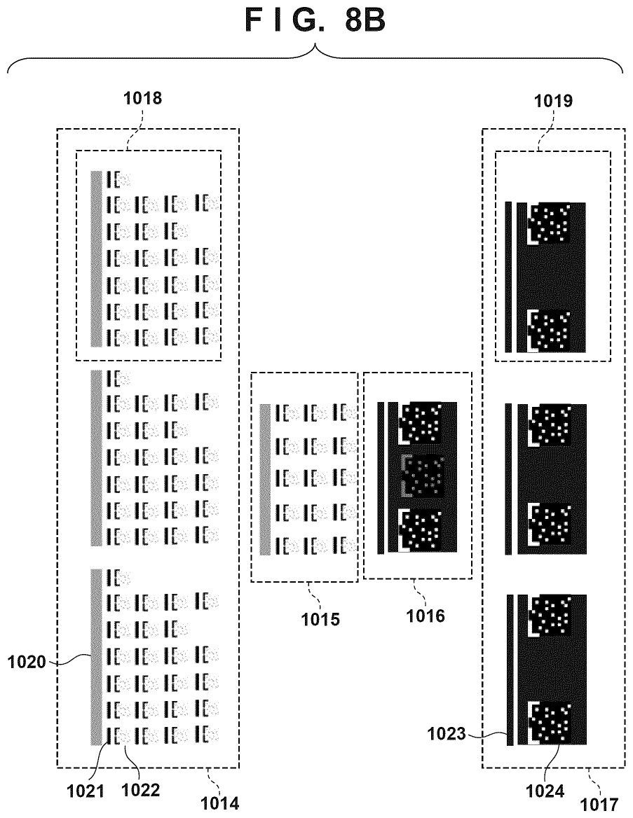

A test pattern 1002 in FIG. 8A is a test pattern for correcting the head position shift of the printhead 100. The test pattern 1002 includes test patterns 1006 to 1012 each corresponding to one of the five printheads 100. In other words, the test patterns 1006 to 1012 are test patterns each corresponding to one of K ink, C ink, M ink, Y ink, and pretreatment solution. These test patterns can also be test patterns for detecting position shift amounts corresponding to the respective printheads 100.

The reading results of these test patterns are used to calculate a shift amount between the printing chips 10 of the corresponding printhead 100, an inter-array shift amount between nozzle arrays, and the inclination amount of the printhead. Note that the test patterns constituting the test pattern 1002 may be increased/decreased from those corresponding to the five printheads, or the order of the test patterns may be changed.

FIG. 8A schematically shows the entire test pattern, and FIG. 8B shows an enlarged part of the test pattern in detail. FIG. 8B shows a pattern 1014 as an enlarged part of the test pattern 1006 corresponding to K ink. The test patterns 1007, 1008, and 1009 corresponding to the respective C, M, and Y inks also have a shape similar to that of the test pattern 1006. The test pattern 1010 is a pattern corresponding to a position shift amount between K, C, M, and Y colors, and a test pattern 1015 is an enlarged pattern of the test pattern 1010. FIG. 8B also shows patterns 1016 and 1017 as enlarged parts of the two types of test patterns 1011 and 1012 corresponding to the pretreatment solution. Note that these patterns are merely an example, and the correspondence between each test pattern and the ink color based on the type of printhead 100 may be changed.

Compared to the pattern 1014, the patterns 1016 and 1017 use upsized patterns, respectively. When a pattern image is printed with a pretreatment solution on a base prepared by applying K ink onto a print medium, the reading accuracy can be increased even with a small luminance difference between the pattern and the base.

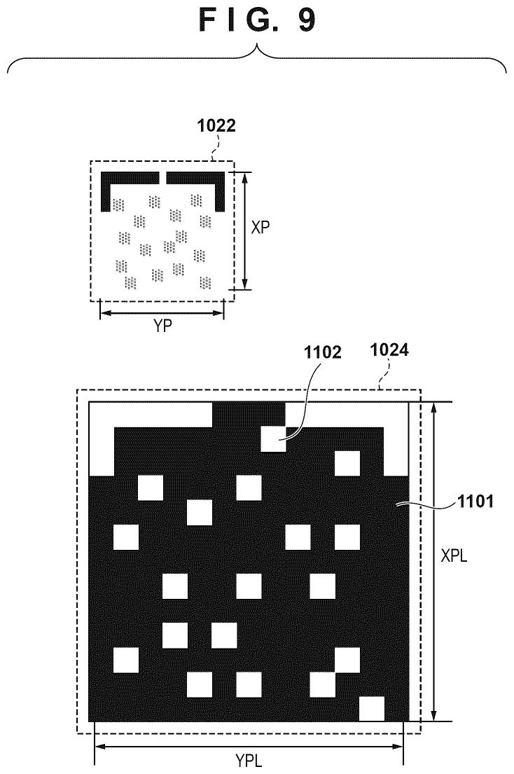

In a pattern matching pattern 1024 shown in FIG. 9, a pattern 1101 represents a region formed with K ink, and a pattern 1102 represents a region formed with the pretreatment solution on the base of the pattern 1101. In this embodiment, the luminance difference between the pattern 1101 and the pattern 1102 is increased by applying the pretreatment solution to only a portion corresponding to the pattern 1102 out of the base of the pattern 1101. However, a large luminance difference may be implemented by applying a predetermined amount of pretreatment solution per unit area to the entire base of the pattern 1101, and further applying more than the predetermined amount of pretreatment solution to the pattern 1102.

Note that in the pattern 1014, a pattern 1018 is a pattern corresponding to one printing chip 10 for discharging K, C, M, or Y ink. In the pattern 1017, a pattern 1019 is a pattern corresponding to one printing chip for discharging the pretreatment solution.

In each of the patterns 1014, 1015, 1016, and 1017, a region expressed in black is a region printed in a corresponding print color. A region expressed in white is a region in the base color of a print medium P and not printed in a print color.

In the printhead 100, the printing chips 10 are aligned as shown in FIG. 6, and the corresponding pattern 1018 or 1019 is linearly printed in parallel with the nozzle array direction 1003 for each printing chip 10.

Here, the configuration and printing method of the pattern 1018 or 1019 corresponding to the printing chip 10 will be explained with reference to FIG. 8B.

The pattern 1018 corresponding to the printing chip 10 is constituted by a detection mark 1020, an alignment mark 1021, and a pattern matching pattern 1022. In contrast, the pattern 1019 corresponding to the printing chip 10 is constituted by a detection mark 1023 and the pattern matching pattern 1024.

The detection marks 1020 and 1023 are patterns used to detect a pattern corresponding to the printing chip 10 in a read image by image analysis processing, and are patterns printed in rectangular regions as shown in FIG. 8B. Since each printing chip 10 includes a plurality of nozzle arrays, the detection marks 1020 and 1023 are printed by discharging ink from the nozzle arrays. By printing with a plurality of nozzle arrays, even when there is a discharge failure nozzle, ink is discharged from the nozzles of another nozzle array, reducing the loss of the detection pattern caused by the discharge failure nozzle. Hence, the detection mark can be stably detected in image analysis processing.

The alignment mark 1021 is a pattern for calculating the reference positions of the analysis regions of the pattern matching patterns 1022 and 1024 in image analysis processing. The alignment mark 1021 is a pattern printed in a rectangular region as shown in FIG. 8B, and is printed by ink discharge from the nozzle arrays of a plurality of columns for each of the pattern matching patterns 1022 and 1024 corresponding to nozzle arrays.

The pattern matching patterns 1022 and 1024 are patterns for detecting a head position shift in image analysis processing. Either the pattern matching pattern 1022 or 1024 is selectively used in accordance with the print color and the type of shift amount to be calculated.

Since the difference in the signal of a luminance value between the base color and print color of the print medium P is small for a pattern formed with the pretreatment solution, a position shift is detected using the large pattern matching pattern 1024. FIG. 9 is a view showing the detailed layouts of the pattern matching patterns 1022 and 1024.

In FIG. 9, XP represents the number of pixels of the pattern matching pattern 1022 in the X direction, YP represents the number of pixels in the Y direction, XPL represents the number of pixels of the pattern matching pattern 1024 in the X direction, and YPL represents the number of pixels in the Y direction. In this embodiment, YP is a direction orthogonal to the nozzle array direction 1003, and XP is a direction parallel to the nozzle array direction 1003, and the values of both YP and XP are 82 pixels at 1,200 dpi. YPL is a direction orthogonal to the nozzle array direction 1003, XPL is a direction parallel to the nozzle array direction 1003, and the values of both YPL and XPL are 210 pixels at 1,200 dpi. Note that these numbers of pixels may be other values.

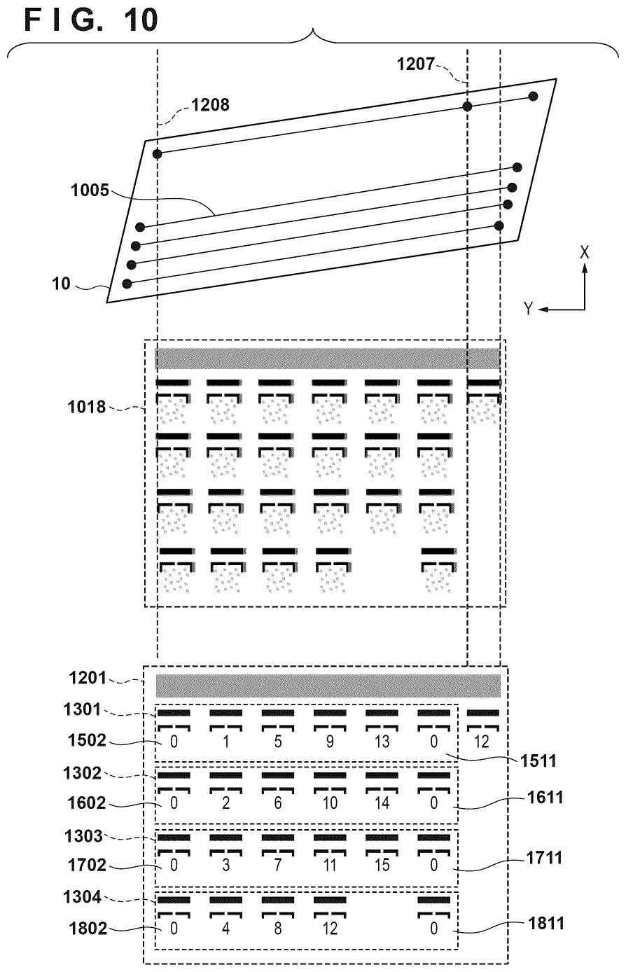

FIG. 10 is a view showing the correspondence between the pattern 1016 corresponding to the printing chip 10, and discharge nozzles. The nozzle array 1005 of the printing chip 10 is constituted by a plurality of nozzles, and 16 nozzle arrays are arranged on one printing chip 10. A test pattern for one printing chip 10 is printed using nozzles within a range defined by broken lines 1207 and 1208 out of the nozzles of each nozzle array 1005 of the printing chip 10. Note that this range may differ depending on the arrangement of a head chip.

The pattern matching pattern of the pattern 1018 for one printing chip 10 is a pattern corresponding to a nozzle array of each number in a test pattern 1201, and is printed using a nozzle array of the corresponding number. A print position shift in the X direction from a nozzle array of a column other than the 0th column is calculated with respect to a pattern of the 0th column in accordance with the arrangement of nozzles that print the test pattern 1201. In print position shift correction between nozzle arrays, first, the test pattern 1201 is divided into four regions 1301 to 1304, as shown in FIG. 10. In the region 1301, 0th column patterns 1502 and 1511 are used as a reference. Even in the regions 1302, 1303, and 1304, 0th column patterns 1602 and 1611, 1702 and 1711, and 1802 and 1811 are similarly used as a reference. In each of the regions 1301 to 1304, two 0th column patterns are used as a reference, and print position shift amounts from patterns printed using other nozzle arrays are calculated. The pattern 1018 is printed for one printing chip 10. The position shift of each printing chip 10 and the inclination of the printhead 100 can be calculated from one pattern matching pattern for one nozzle of each pattern 1018.

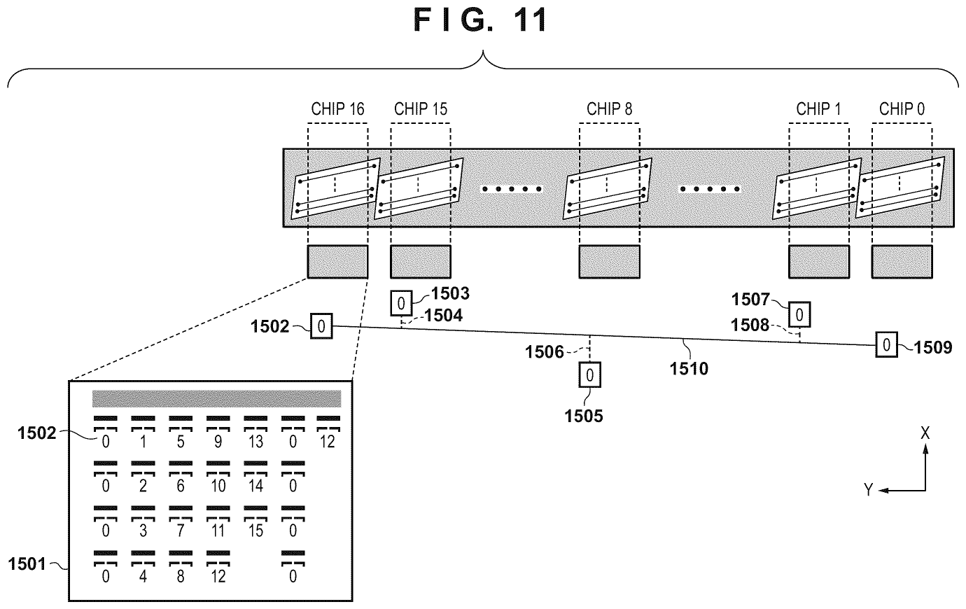

FIG. 11 is a view showing a method of calculating a shift amount between the printing chips 10 in the X direction. One printhead 100 includes 17 printing chips 10 arranged in the Y direction. The respective printing chips 10 are numbered such that the first printing chip 10 counted from the negative side in the Y direction is chip 0, and the final printing chip is chip 16. In FIG. 11, the right side is the near side of the printing apparatus A in FIG. 1, and the left side is the far side of the printing apparatus A.

A method of calculating a shift amount between the printing chips 10 using a reading result (scanned image) obtained by reading a printed test pattern by the reading unit 302 will be explained with reference to FIG. 11.

FIG. 11 shows a pattern 1501 printed using chip 16 in accordance with the layout of the test pattern 1201. The pattern includes a tile pattern 1502 printed by a nozzle array of the 0th column.

A line 1510 connecting the barycenter of the pattern 1502 printed by chip 16 and that of a pattern 1509 printed by chip 0 will be called an intra-printhead reference line. The intra-printhead reference line can also be called an intra-printhead reference position.

A shift amount between the printing chips 10 in the X direction is the distance of a perpendicular dropped to the intra-printhead reference line from the barycenter of a tile pattern printed by a nozzle array of the 0th column of each printing chip 10. For example, a distance 1504 of a perpendicular dropped to the intra-printhead reference line 1510 from the barycenter of a tile pattern 1503 printed by a nozzle array of the 0th column of chip 15 is a shift amount between the printing chips for chip 15 in the X direction.

Similarly, a distance 1506 of a perpendicular dropped to the intra-printhead reference line 1510 from the barycenter of a tile pattern 1505 printed by a nozzle array of the 0th column of chip 8 is a shift amount between the printing chips for chip 8 in the X direction. Similarly, a distance 1508 of a perpendicular dropped to the intra-printhead reference line 1510 from the barycenter of a tile pattern 1507 printed by a nozzle array of the 0th column of chip 1 is a shift amount between the printing chips for chip 1 in the X direction. Shift amounts are similarly calculated even for the remaining printing chips 10 (not shown).

In the printing apparatus A including the plurality of printheads 100, as in this embodiment, a reference line is sometimes derived from the plurality of printheads 100 when executing inclination correction between the printheads 100. This reference line will be called an inter-printhead reference line. The inter-printhead reference line can also be called an inter-printhead reference position.

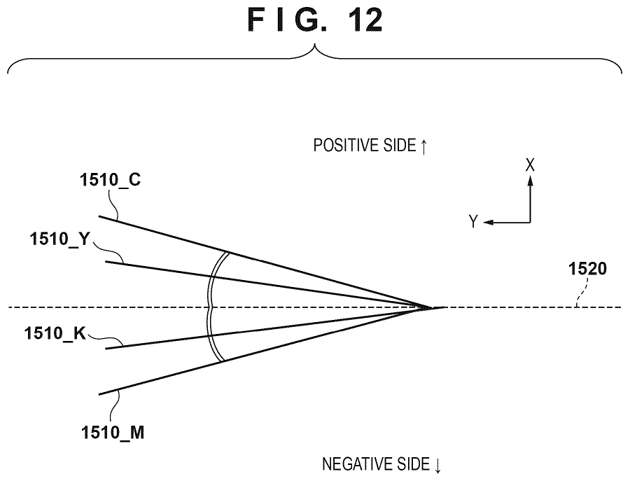

FIG. 12 is a schematic view showing an example of a method of correcting an inclination between the printheads 100. The intra-printhead reference lines 1510 on the side of chip 0 to chip 8 on each printhead 100 are discriminated by ink colors and will be referred to as intra-printhead reference lines 1510_K, 1510_C, 1510_M, and 1510_Y. An upper side in FIG. 12 is defined as the positive side of an inclination, and a lower side is defined as the negative side of the inclination. A line bisecting an angle defined by the intra-printhead reference line 1510_C most inclined to the positive side and the intra-printhead reference line 1510_M most inclined to the negative side will be referred to as an inter-printhead reference line 1520.

Note that the inter-printhead reference line 1520 may be specified by the average value of the inclinations of the printheads 100. The inter-printhead reference line is calculated using four printheads 100 of colored inks in the example of FIG. 12, but may be calculated using five printheads 100 including the printhead of the pretreatment solution. The average value of the inclinations of the printheads 100 excluding the outermost printheads 100 may be used.

### (Influence of Curve of Reading Unit)

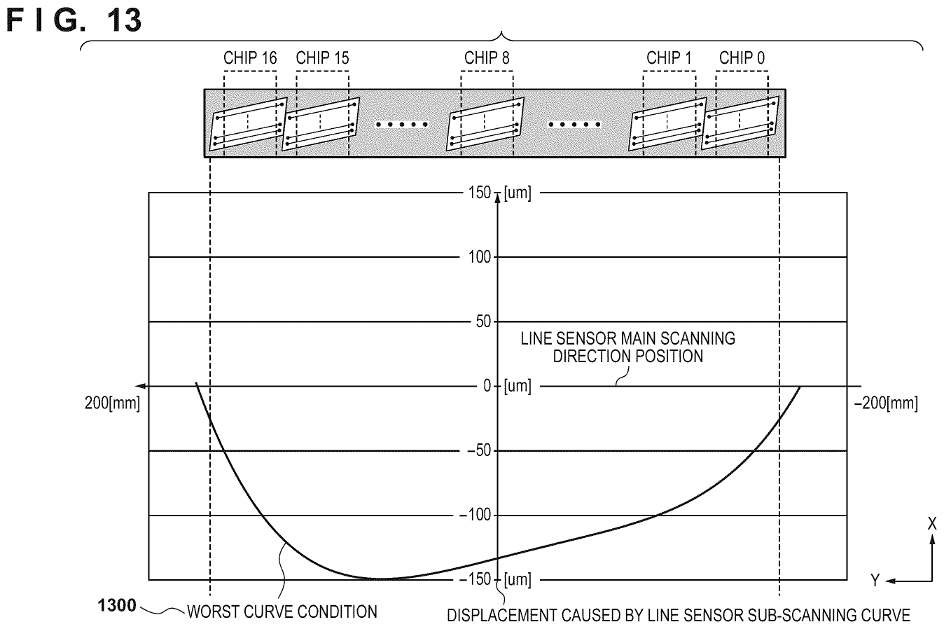

The influence of the curve of the line sensor 300 on detection of an X shift amount between the printing chips 10 will be explained. Assuming a worst case 1300 as exemplified in FIG. 13, when the peak of the curve comes close to the printing chip 10 at the end portion of the printhead 100 in the Y direction, the curvature of the curve increases. This increases the influence of a reading error (also called a curve component) with respect to calculation of a shift amount between the printing chips for the printing chip 10 at the end portion.

The study has shown that, assuming the worst conditions of the standards (peak position and degree of curve) of the line sensor 300 in shipment, if position shift correction is executed using the curved line sensor 300, the influence of the curve becomes very large. Under the strong influence of the curve of the line sensor 300, it is difficult to make a print position shift fall within the standard even by correction.

### (Correction of Curve Component Using Inter-Printing Chip Shift Correction Value)

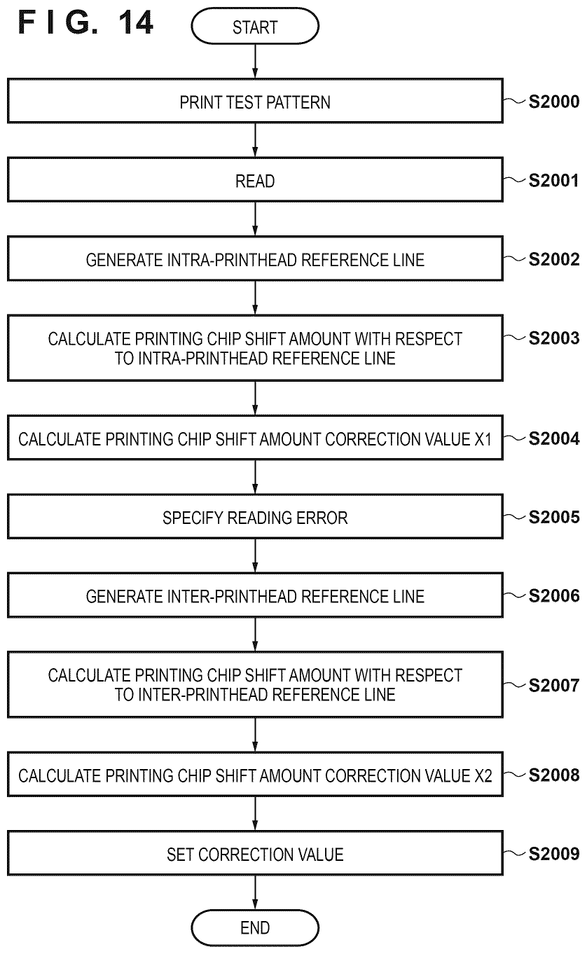

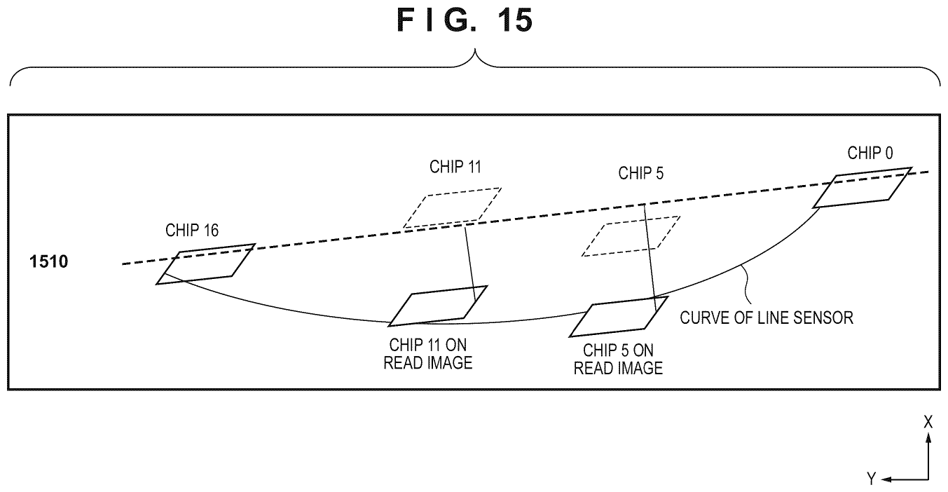

FIG. 14 is a flowchart showing a method of correcting a curve component using a shift correction value between the printing chips 10, and setting the correction value of a print position shift. For example, the read image processing unit 304 can mainly execute this processing. FIG. 15 is a view schematically showing this method.

The processing in FIG. 14 is executed at the time of installing the printing apparatus A, after replacing the printhead 100, or after maintaining the printhead 100. Note that curve correction of the line sensor 300 may be executed not at the timing of print position shift correction, but as a single operation.

Note that this embodiment assumes a case where the following processing is performed not at the time of factory shipment but at the timing when the printing apparatus A is installed in a usage place. This is because the degree of curve of the line sensor 300 may change during distribution or over time, and correction can be performed more accurately at the timing when the printing apparatus A is installed.

In the flowchart of FIG. 14, in step S2000, while a sheet is conveyed by the engine controller 13B, each printhead 100 is driven to print the test pattern 1002 on the sheet. In step S2001, while the sheet is conveyed, the image reading control unit 303 controls the reading unit 302 to read the test pattern printed on the sheet.

Then, in step S2002, the read image processing unit 304 generates, from the read image, the intra-printhead reference line 1510 connecting the barycenters of tile patterns printed by nozzle arrays of the 0th columns of chip 0 and chip 16 of each printhead 100. In step S2003, the read image processing unit 304 calculates the lengths of perpendiculars dropped to the intra-printhead reference line 1510 from the barycenters of tile patterns printed by nozzle arrays of the 0th columns of chip 1 to chip 15 of each printhead 100, as shown in FIG. 11. The length is a shift amount between the printing chips 10 in the X direction with respect to the intra-printhead reference line 1510 of each printing chip 10.

This will be explained in detail with reference to FIG. 15. The actual positions of chip 5 and chip 11 indicated by dotted lines change to positions respectively indicated by solid lines under the influence of the curve of the line sensor 300. A perpendicular is dropped to the intra-printhead reference line 1510 to calculate a shift amount between the printing chips 10 including the curve component of the line sensor 300.

In step S2004, the read image processing unit 304 calculates, based on the length calculated in step S2003, a correction value X1 of the shift amount between the printing chips 10 for each printing chip 10 of each printhead. In step S2005, the reading error (curve component) of the line sensor 300 is specified. Here, the curve component of the line sensor is extracted from the shift correction value between the printing chips 10 that corresponds to each printing chip 10 of each printhead 100. As an example, the read image processing unit 304 calculates, from the following equation, an average value X1_ave of the correction value X1 of the shift amount between the printing chips 10 of each printhead 100 for each printing chip 10:

X1(n)_ave=(X1(n)_K+X1(n)_C+X1(n)_M+X1(n)_Y)/4
where K, C, M, and Y are discriminated ink colors (that is, the printheads 100), and n is a chip number. For example, the average value X1_ave of the correction value X1 of each printhead 100 at the position of chip number 3 in the Y direction is given by:

X1(3)_ave=(X1(3)_K+X1(3)_C+X1(3)_M+X1(3)_Y)/4

This is the curve component of the line sensor 300 at that position.

Averaging processing can be performed to increase the S/N ratio of the curve component by the line sensor. A larger number of printheads 100 used in calculation improve the accuracy. In this embodiment, averaging processing is performed between the printheads 100 of the color inks, but the printhead 100 of the pretreatment solution may also be included.

Subsequently, in step S2006, the read image processing unit 304 derives an inter-printhead reference line according to the method shown in FIG. 11. In step S2007, similar to step S2003, the read image processing unit 304 calculates a printing chip shift amount with respect to the inter-printhead reference line. In step S2008, the read image processing unit 304 calculates a correction value X2 of the shift amount between the printing chips 10 with respect to the inter-printhead reference line.

In step S2009, the correction value of the print position is set. Here, the read image processing unit 304 subtracts the curve component X1_ave of the line sensor 300 from the inter-printing chip shift amount correction value X2, calculating a final inter-printing chip shift amount correction value Xa. That is, the final inter-printing chip shift amount correction value Xa is calculated by:

Xa(n)=X2(n)−X1(n)_ave

By the above processing, the correction value of the shift amount between the printing chips 10 excluding the curve component of the line sensor 300 can be obtained. High-accuracy print position shift correction in which the influence of the curve of the line sensor 300 is reduced can be implemented.

Note that two reference lines are selectively used in steps S2003 and S2007 in order to improve the correction accuracy. Reference lines used are not limited to two shown in the flowchart of FIG. 14.

### Second Embodiment: Correction of Curve Component Using High-Order Polynomial

In the first embodiment, printing of test patterns using the printheads 100 and reading of them are necessary. As the second embodiment, high-accuracy curve correction is executed using a single printhead 100. This embodiment is applicable to a printing apparatus with only the single printhead 100. Examples of such a printing apparatus are a monochrome-only printing apparatus equipped with a multi-array K head, and a printing apparatus equipped with a multicolor integral printhead in which ink colors to be discharged are separated between respective arrays for one printing chip. Needless to say, this embodiment is applicable to even a printing apparatus equipped with a plurality of printheads 100.

In this embodiment, at least one generation factor of a shift between printing chips 10, other than a curve, is quantitatively measured to estimate the curve of a line sensor 300. In this embodiment, the distance between the printing chips 10 in the X direction is measured at the time of factory shipment of the printhead 100, and the measurement information is stored in a ROM 100a. In this embodiment, the number of perpendiculars from the respective printing chips 10 to a reference line (in this embodiment, an intra-printhead reference line 1150) is increased to perform correction based on a high-order polynomial.

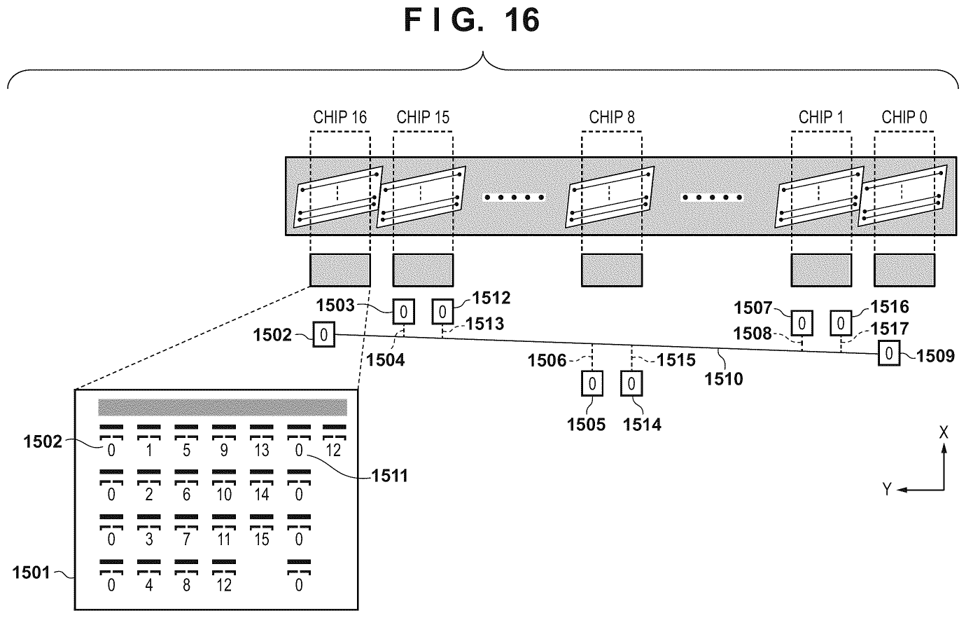

As shown in FIG. 16, as for chip 1 to chip 15 sandwiched between chip 0 and chip 16, the lengths of perpendiculars to an intra-printhead reference line 1510 from the barycenters of tile patterns on the chip 0 side printed by nozzle arrays of the 0th columns, and those of tile patterns on the chip 16 side are calculated.

More specifically, the lengths of perpendiculars to the intra-printhead reference line 1510 from the barycenter of a tile pattern equivalent to a tile pattern 1502 of a pattern 1501, and that of a tile pattern equivalent to a tile pattern 1511 printed by a nozzle array of the same 0th column are calculated. For example, on chip 15 of FIG. 16, a perpendicular 1504 is dropped from the barycenter of a tile pattern 1503 shown in FIG. 11 to the intra-printhead reference line 1510 to calculate the length of the perpendicular 1504. In addition, the length of a perpendicular 1513 dropped from the barycenter of a tile pattern 1512 to the intra-printhead reference line 1510 is calculated.

Similarly, on chip 8 of FIG. 16, the length of a perpendicular 1506 dropped from the barycenter of a tile pattern 1505 shown in FIG. 11 to the intra-printhead reference line 1510, and that of a perpendicular 1515 dropped from the barycenter of a tile pattern 1514 to the intra-printhead reference line 1510 are calculated. Similarly, on chip 1, the length of a perpendicular 1508 dropped from the barycenter of a tile pattern 1507 shown in FIG. 11 to the intra-printhead reference line 1510, and that of a perpendicular 1517 dropped from the barycenter of a tile pattern 1516 to the intra-printhead reference line 1510 are calculated.

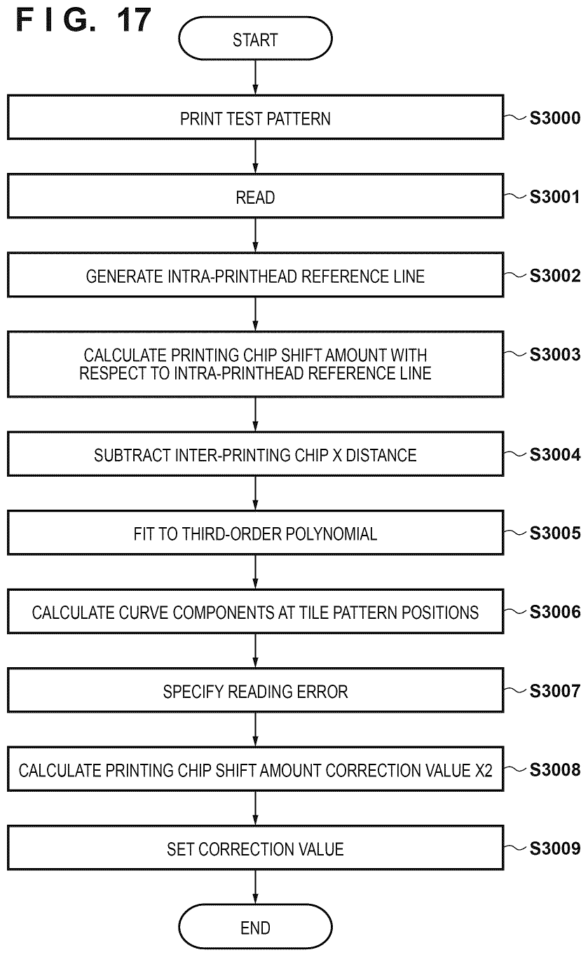

FIG. 17 is a flowchart showing an example of a method of setting a correction value according to this embodiment.

Steps S3000, S3001, and S3002 are similar to steps S2000, S2001, and S2002 shown in FIG. 14 as the first embodiment. In step S3003, as shown in FIG. 16, a read image processing unit 304 calculates, from perpendiculars respectively dropped to the intra-printhead reference line 1510 from two tile patterns of a printing chip 10, the shift amount of each printing chip 10 in the X direction.

In step S3004, the read image processing unit 304 subtracts, from the shift amount of each printing chip 10 in the X direction obtained in step S3003, a distance between the printing chips 10 in the X direction read out from measurement information written in a ROM 100a.

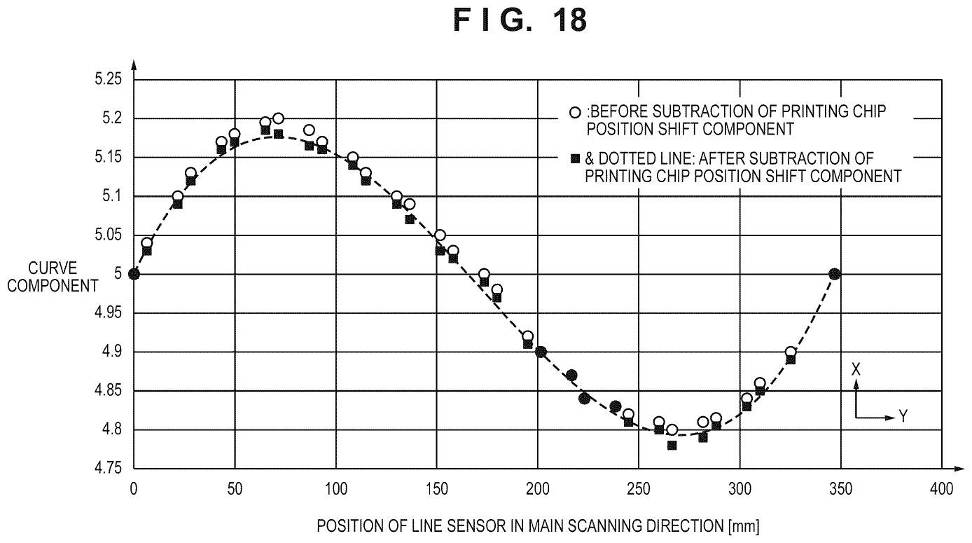

FIG. 18 is a graph showing an example of plotting the X-direction shifts of the barycenters of tile patterns read by the line sensor 300 having a given amount of curve component.

In the graph, the abscissa represents the position of the line sensor 300 in the main scanning direction (Y direction), and the ordinate represents the displacement (curve amount) in the sub-scanning direction (X direction) caused by the curve of the line sensor 300. ◯ represents a result obtained in step S3003, and ▪ and a dotted line represent a result of subtracting measurement information stored in the ROM 100a.

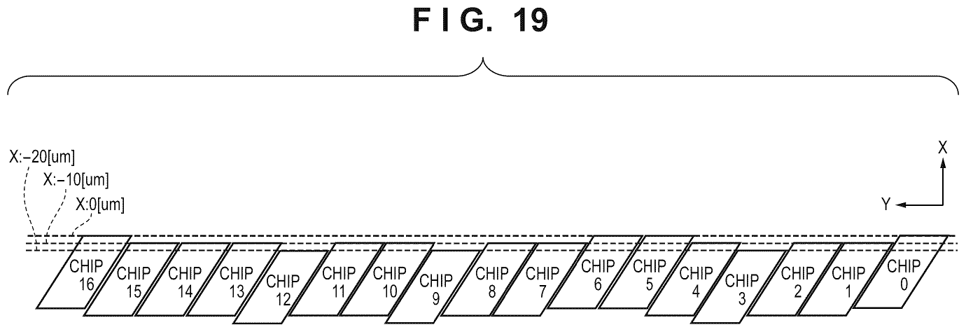

FIG. 19 is a view schematically showing measurement information stored in the ROM 100a exemplified in FIG. 18. The measurement information in this embodiment represents the measurement value of the X-direction displacement of each portion in the curve direction of the line sensor 300, that is, in the Y direction. The measurement information represents, for example, in units of 10 microns, how many tens of microns each printing chip 10 displaces in the X direction with respect to chip 0. For example, measurement information “−10 microns” is stored for chip 1. The stored measurement information is not limited to measurement information in the X direction, and may include even measurement information in the Y direction.

Referring back to FIG. 17, in step S3005, the read image processing unit 304 performs approximation calculation from the plot of ▪ marks to a high-order polynomial. In this embodiment, the approximation calculation to a third-order polynomial is performed using a least-square method. The approximation calculation may be performed by a polynomial of an order other than third-order. Also, the approximation method may use a calculation other than the least-square method. The polynomial is given by, for example:

polynomial: y=0.0000001x\hat{ }3−0.0000497x\hat{ }2+0.0055988x+5.0070297

In step S3006, the read image processing unit 304 calculates, from the polynomial, curve components of the line sensor 300 at the positions of two tile patterns of each printing chip 10. In step S3007, the read image processing unit 304 specifies a curve correction value X1 of each printing chip 10 as a reading error. In this embodiment, the average value of curve components at the positions of two tile patterns is used, but weighting or the like may be performed.

Then, in step S3008, similar to the first embodiment, the read image processing unit 304 calculates a correction value X2 of the shift amount between the printing chips 10 with respect to the inter-printhead reference line 1510.

Finally, in step S3009, the read image processing unit 304 subtracts the curve component X1 from the correction value X2, and sets a final correction value Xa of the shift amount between the printing chips 10 by:

Xa=X2−X1

By the above processing, a curve correction value can be extracted at high accuracy by approximating the curve component of the line sensor 300 to a high-order polynomial using measurement information of a shift between the printing chips 10 measured in advance. Thus, high-accuracy correction of the print position shift amount between the printing chips 10 can be implemented.

### Third Embodiment: Storage of History Information

The first and second embodiments assume a case where a curve component is specified at the timing when print position shift correction is performed. However, if a temporal change of the degree of curve of a line sensor 300 along with the use of a printing apparatus A is small, the curve component specifying result may be stored as a history in a storage device. The storage device may be a storage unit 132. A mechanism may be adopted to increase the curve correction accuracy while referring to the specifying result.

### Fourth Embodiment: Correction of Curve Component Using Master Chart

In the fourth embodiment, a correction method using a master chart (reference pattern) is executed. This embodiment is effective especially when a change of the degree of curve of a line sensor 300 during distribution or over time is small, and the degree of curve of the line sensor 300 at the time of factory shipment is maintained.

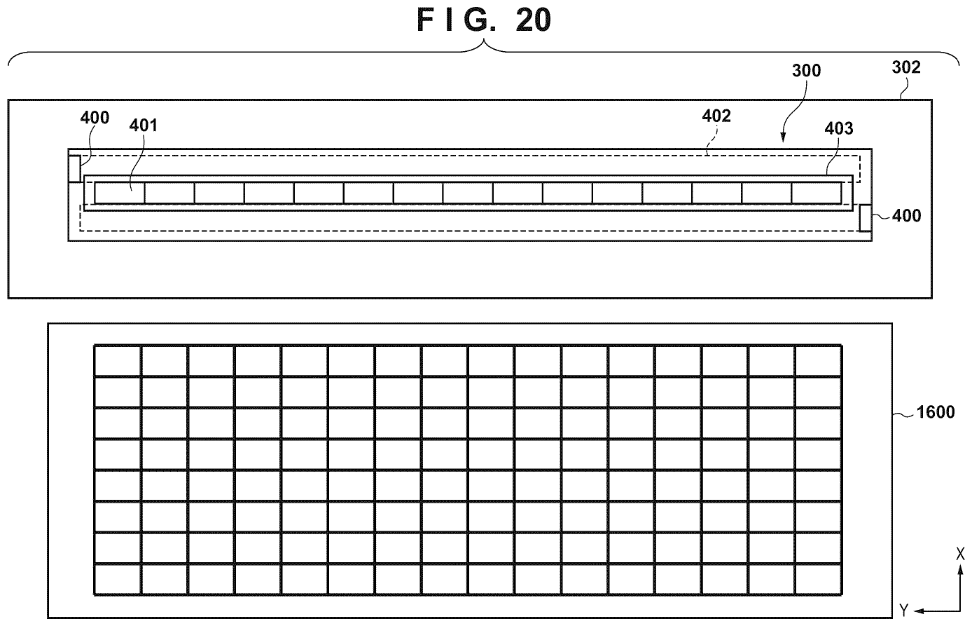

FIG. 20 is a view showing an example of a reading unit 302 and a master chart 1600. The master chart is a grid-like pattern, and vertical and horizontal lines are orthogonal to each other. The master chart 1600 has in the Y direction a width equivalent to the entire width of a chip group of sensor chips 401 of the line sensor 300. As an example, the master chart 1600 is assumed to be rendered on a film of B3 (X: 515 mm, Y: 364 mm) size. A material such as a low thermal shrinkage plastic or glass may be used.

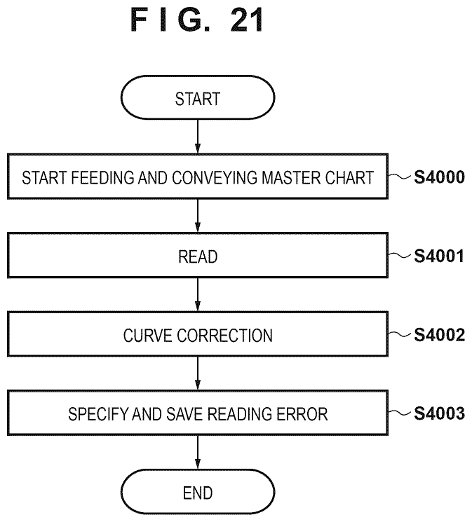

FIG. 21 is a flowchart showing a sequence of correction of a curve component using the master chart 1600. In step S4000, an engine controller 13B starts feeding and conveying the master chart 1600 set in a paper feed unit. At this time, a printhead 100 does not print an image. In step S4001, an image reading control unit 303 controls the reading unit 302 to read the master chart 1600.

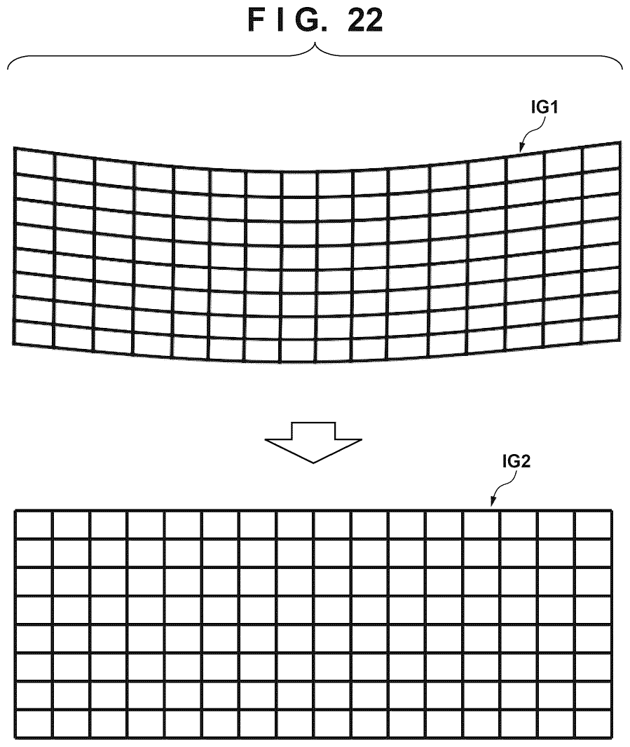

In step S4002, the image reading control unit 303 analyzes the read image, and performs curve correction of the read image so that the grids of the master chart are equally spaced without any distortion. FIG. 22 is a view showing the corrected image of an image IG2 obtained by correcting the curve of a read image IG1.

In step S4003, a correction value obtained in step S4002 is specified as a reading error. A main controller 13A obtains the curve correction value and writes it in a storage unit 132. The obtained curve correction value is used when, for example, setting a print position shift correction value using a test pattern. For example, when executing adjustment of the print position at the time of installing the printing apparatus A, the image reading control unit 303 read a test pattern 1002 printed on a print medium by the printhead 100. Then, curve correction is executed with the curve correction value on the entire read image. A print position shift correction value is set using the read image after the curve correction. As the timing of use of the curve correction value, a print position shift correction value may be temporarily calculated from the read image of a test pattern, and then corrected with the curve correction value, setting a final correction value.

By the above processing, a master chart formed from an ideal grid pattern is read, and a curve correction value is calculated so that the read image becomes an ideal grid pattern. The reading error of the line sensor 300 can be specified without printing a test pattern by the printhead 100.

Note that this embodiment may be executed mainly at the time of factory shipment or service support such as unit replacement. This embodiment may also be combined with curve correction executed at the timing of print position shift correction described in the first and second embodiments.

### Fifth Embodiment

A reading error caused by the curve of a line sensor 300 may be specified by twice reading a test pattern printed by a printhead 100 while changing the orientation. More specifically, the test pattern is read once by the reading unit 302. Then, the test pattern is flipped vertically in the X direction so that the orientation is reversed in the X direction. After that, the test pattern is read again by the reading unit 302. The first read image and the second image read after vertical flip are used to extract the curve component of the line sensor 300.

The curve component is extracted from a difference between a print position shift amount between printing chips 10 obtained by analyzing the first reading result, and a print position shift amount between the printing chips 10 obtained by analyzing the second reading result.

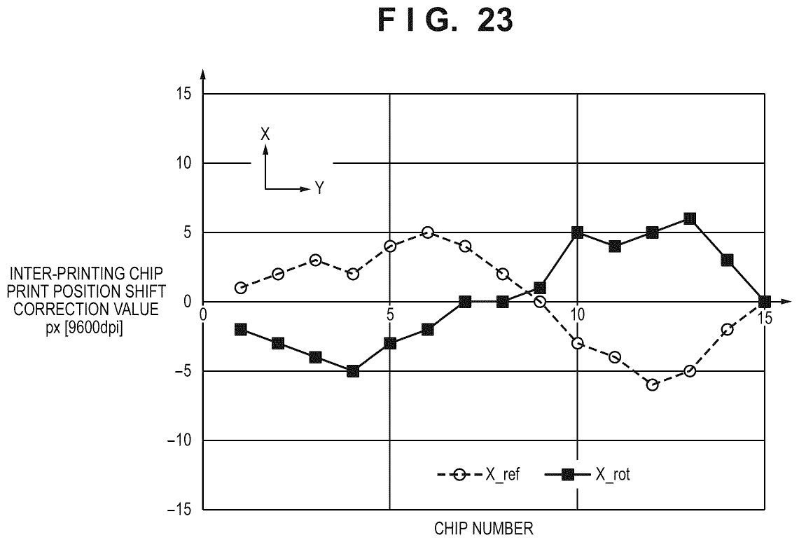

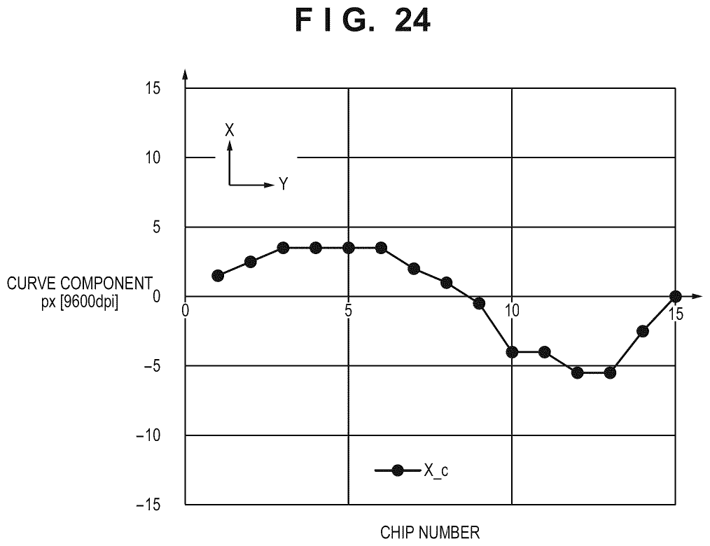

This will be explained below with reference to FIGS. 23 and 24. In the graph of FIG. 23, the abscissa represents the chip number of the printing chip 10, and the ordinate represents the print position shift amount [pixel/9600 dpi]. ◯ and a dotted line represent a first shift amount X_ref, and ▪ and a solid line represent a second shift amount X rot. The shift amount is a position shift amount between the printing chips 10.

Then, X rot is subtracted from X_ref. Only by subtraction, double the curve component of the line sensor 300 is calculated. Therefore, a line sensor curve component X_c is calculated by:

X_c=|X_ref−X_rot)/2|

FIG. 24 is a graph showing the calculation result of X_c.

A final print position shift correction value Xa excluding the curve component is set as:

Xa=X_ref−X_c

Note that in this embodiment, the shift amount may be analyzed after a curve component correction value is reflected in the read image of a test pattern, like the fourth embodiment. Note that a test pattern-printed sheet may be flipped automatically by an automatic reversing mechanism installed in the printing apparatus A, or may be fed again by the user.

### OTHER EMBODIMENTS

The present disclosure can be implemented by supplying a program for implementing one or more functions of the above-described embodiments to a system or apparatus via a network or storage medium and causing one or more processors in the computer of the system or apparatus to read out and execute the program. The present disclosure may be implemented by a circuit (for example, an ASIC) that implements one or more functions.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-034030, filed Mar. 4, 2025, which is hereby incorporated by reference herein in its entirety.

What is claimed is:

1. A printing apparatus comprising:
a conveyance unit configured to convey a print medium in a first direction;
a printing unit including at least one printhead configured to discharge a liquid to the print medium;
a reading unit including a plurality of reading elements arrayed in a second direction crossing the first direction;
a specifying unit configured to specify a reading error arising from a curve of the reading unit in the first direction; and
a correcting unit configured to set a correction value for correcting a shift of a print position of the printing unit based on a reading result by the reading unit from a test pattern printed on the print medium by the printing unit, and the reading error specified by the specifying unit.

2. The apparatus according to claim 1, wherein the specifying unit is configured to specify the reading error based on the reading result of the test pattern.

3. The apparatus according to claim 2, wherein the printing unit includes a plurality of printheads,
the test pattern includes a pattern printed by each printhead, and
the specifying unit is configured to specify the reading error based on the pattern of each printhead.

4. The apparatus according to claim 3, wherein each printhead includes a plurality of chips arranged in a longitudinal direction of the printhead that crosses the first direction,
each chip includes a plurality of nozzles arranged in the longitudinal direction, and
the specifying unit is configured to specify, for each printhead, a position shift of each chip in the first direction with respect to a reference position, and to specify an average value of position shifts of corresponding chips of each printhead as the reading error.

5. The apparatus according to claim 2, wherein the printhead includes a plurality of chips arranged in a longitudinal direction of the printhead that crosses the first direction,
each chip includes a plurality of nozzles arranged in the longitudinal direction, and
the specifying unit is configured to obtain information of a position shift of each chip in the first direction that is measured in advance, and to specify the reading error based on the information and the reading result of the test pattern.

6. The apparatus according to claim 5, wherein the specifying unit is configured to specify, based on the reading result of the test pattern, a position shift of each chip in the first direction with respect to a reference position, and to derive a polynomial that approximates the curve of the reading unit based on a difference between the specified position shift and a position shift represented by the information.

7. The apparatus according to claim 1, wherein the specifying unit is configured to specify the reading error based on a reading result by the reading unit from a reference pattern different from the test pattern.

8. The apparatus according to claim 7, wherein the reference pattern is a grid-like pattern.

9. The apparatus according to claim 1, wherein the specifying unit is configured to specify the reading error based on results of reading twice the test pattern by the reading unit, and
orientations of the test pattern in first reading and second reading of the test pattern are opposite in the first direction.

10. The apparatus according to claim 1, wherein a specifying result of the specifying unit is stored in a storage unit.

11. The apparatus according to claim 1, wherein a discharge timing of the printing unit is corrected based on the correction value.

12. The apparatus according to claim 1, wherein the printhead is a full-line head.

13. A method of controlling a printing apparatus including: a conveyance unit configured to convey a print medium in a first direction; a printing unit including at least one printhead configured to discharge a liquid to the print medium; and a reading unit including a plurality of reading elements arrayed in a second direction crossing the first direction, the method comprising:
specifying a reading error arising from a curve of the reading unit in the first direction; and
setting a correction value for correcting a shift of a print position of the printing unit based on a reading result by the reading unit from a test pattern printed on the print medium by the printing unit, and the reading error specified in the specifying.
